(19) United States
(12) Patent Application Publication
(10) Pub. No.: US 2007/0199536 A1
(43) Pub. Date: Aug. 30, 2007

(54) METHODS AND SYSTEMS EMPLOYING INTERSECTING VANE MACHINES

(76) Inventors: Alexander P. Doohovskoy, Concord, MA (US); Eric D. Ingersoll, Cambridge, MA (US)

Correspondence Address: ELMORE PATENT LAW GROUP, PC, 209 MAIN STREET, N. CHELMSFORD, MA, 01863, US

(21) Appl. No.: 11/696,407

(22) Filed: Apr. 4, 2007

Related U.S. Application Data
(63) Continuation-in-part of application No. 11/507,065, filed on Aug. 18, 2006.
(60) Provisional application No. 60/709,368, filed on Aug. 18, 2005.

(51) Int. Cl. F02B 53/00

(52) U.S. Cl. 123/241

(57) ABSTRACT

The invention provides a toroidal intersecting vane machine incorporating intersecting rotors to form primary and secondary chambers whose porting configurations minimize friction and maximize efficiency. Specifically, it is an object of the invention to provide a toroidal intersecting vane machine that greatly reduces the frictional losses through meshing surfaces without the need for external gearing by modifying the function of one or the other of the rotors from that of “fluid moving” to that of “valving” thereby reducing the pressure loads and associated inefficiencies at the interface of the meshing surfaces. The inventions described herein relate to these improvements.

### RELATED APPLICATIONS

This application is a continuation in part of U.S. Ser. No. 11/507,065 filed on Aug. 18, 2006 which claims benefit of U.S. Provisional Application No. 60/709,368 filed on Aug. 18, 2005, the entire contents of which are incorporated herein by reference.

### GOVERNMENT SUPPORT

The invention was supported, in whole or in part, by a grant from Department of Energy. The Government has certain rights in the invention.

### BACKGROUND OF THE INVENTION

Machines incorporating intermeshing rotors have been described and are commonly referred to as Toroidal Intersecting Vane Machines (TIVM). See Chomyszak, U.S. Pat. No. 5,233,954, issued Aug. 10, 1993, and Tomcyzk, United States Patent Application Publication 2003/0111040, published Jun. 19, 2003. The contents of the patent and publication are incorporated herein by reference in their entirety. The TIVM requires meshing surfaces along the leading and trailing faces of its Primary and Secondary vanes, which come into sufficiently close proximity to each other, to form a seal so as to allow the TIVM to compress, expand, or pump a fluid. In addition, the meshing surfaces must provide minimum friction, minimum wear, minimum noise, and acceptable kinematic characteristics to allow the TIVM to operate efficiently and reliably. The surfaces must be scalable and manufacturable. This means that they need to be “describable” at a highly detailed level.

The prior art concerning intersecting vane machines of spherical, cylindrical, as well as toroidal geometry, refer to the shapes of the meshing surfaces as being generally ‘beveled’ or ‘helical’ in nature, suggesting that previous inventors of intersecting vane machinery knew at an instinctual level what the shapes of the surfaces would look like. But, they were without the means to refine the shapes into functioning engineered surfaces capable of satisfying the above needs required for practical machinery.

### SUMMARY OF THE INVENTION

Accordingly, it is an object of this invention to provide a toroidal intersecting vane machine incorporating intersecting rotors with vanes having intermeshing surfaces or intermeshing faces that are essentially the same, are fully or partially congruent, and/or have minimal gaps and/or interferences during rotation and vanes for use therein.

### BRIEF DESCRIPTION OF THE DRAWINGS

FIG. 1A-1D depict a primary and secondary vane.

FIG. 2 illustrates the path of the primary vanes 11 and secondary vanes 12 in two dimensions, the XY Plane and ZX Plane are also depicted.

FIG. 3A-3H show the geometric frame of reference for the torus and a single embedded cylinder.

FIG. 4A-4C provide a view wherein a quarter of the torus is cutaway. The inner torus of the geometric framework is clearly shown as well as the meshing region of the primary vane and secondary vane.

FIG. 5 illustrates the first meshing surfaces of the primary and secondary vanes at first touch of the meshing phase.

FIG. 6A-6B illustrate the admissible and overlap regions on a meshing region of a primary vane.

FIG. 6C illustrates the beginning of the intermeshing of a primary and secondary vane.

### DETAILED DESCRIPTION OF THE INVENTION

The invention provides a substantially improved toroidal intersecting vane machine herein disclosed and vanes useful therein.

It is known that the meshing surface solution involves the simultaneous rotation of two shapes. As pertains to the TIVM (and other similarly intermeshing machines or gears), and as taught in U.S. Pat. No. 5,233,954, the two shapes being rotated have certain geometric qualities: shape #1 should be internally concave, such as the inside of a torus, and shape #2 should be externally convex, such as the outside of a cylinder. Both shapes are surfaces or solids of revolution wherein neither of their respective axes of revolution intersect and their planes of revolution are anything other than parallel. When combined, the above attributes define the geometry and are the starting point for the solution of the meshing surface shapes.

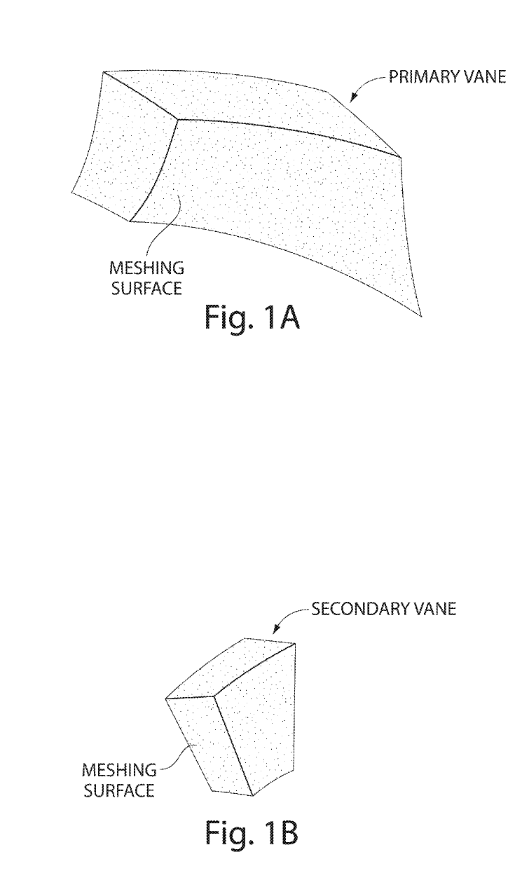

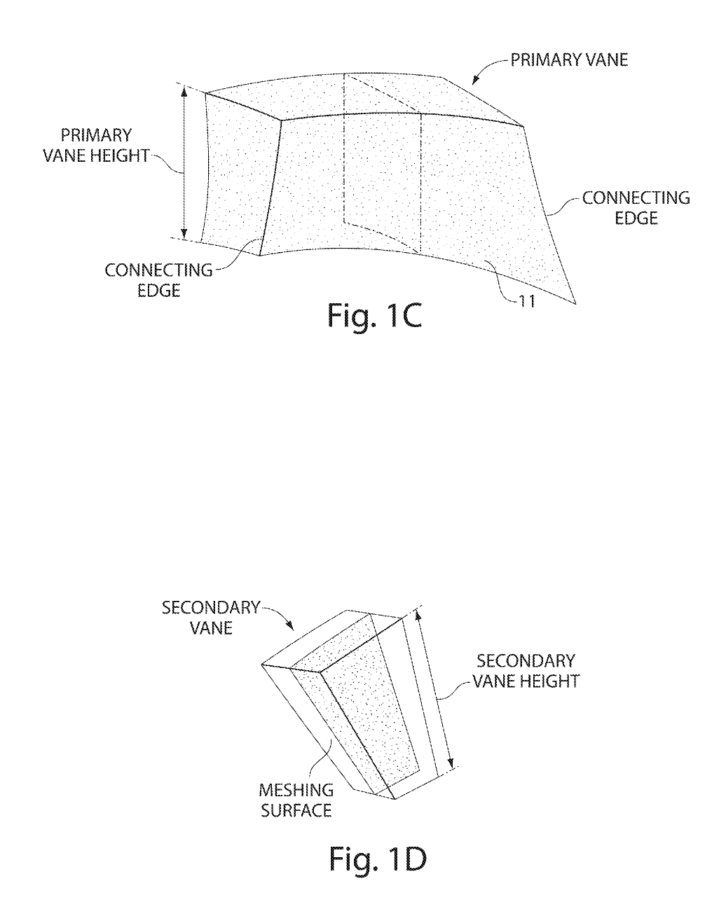

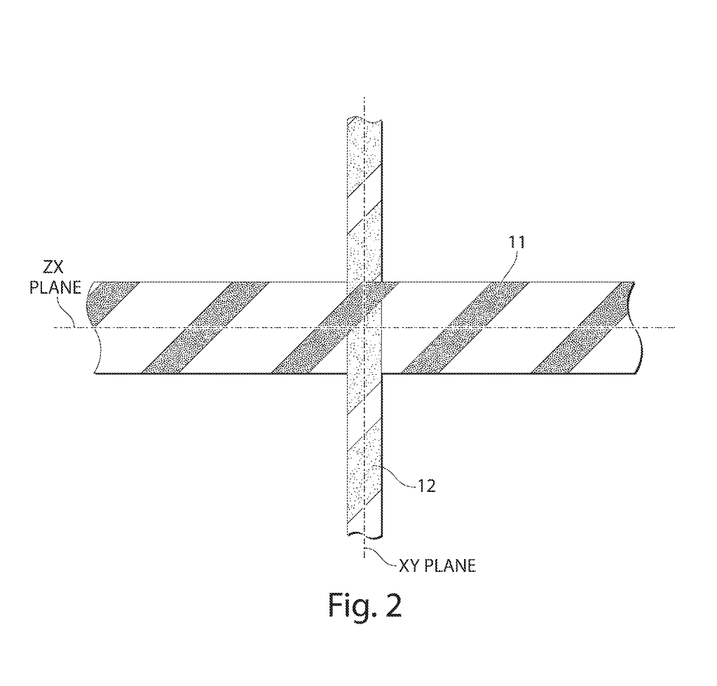

FIGS. 1A and 1C depicts a primary vane, showing the meshing surface 11, vane height and connecting edge. FIGS. 1B and 1D depicts a secondary vane, also showing the vane height and meshing surface. FIG. 2 illustrates the path of the primary vanes 11 and secondary vanes 12 projected in two dimensions, the three dimensional XY Plane and ZX Plane are also depicted.

FIG. 2 also illustrates that each vane has a leading and trailing surface (with respect to the direction of motion). The leading and trailing meshing surfaces of a primary vane can be the same (congruent) or different from one another. Similarly, the leading and trailing meshing surfaces of a secondary vane can be the same (congruent) or different from one another. During the operation of a TIVM, the leading surface of a primary vane intermeshes with the trailing surface of a secondary vane. Also the trailing surface of a primary vane intermeshes with the leading surface of a secondary vane. We therefore refer to these pairs of surfaces as intermeshing surfaces when we wish to emphasize their mutual interaction. This intermeshing interaction between these pairs of surfaces is the result of the simultaneous rotation of the primary vanes and secondary vanes with respect to their respective axes of rotation. When referring to the surfaces individually we will refer to them as meshing surfaces.

Chomyszak et al. proposed a possible set of equations to the meshing surface solution in U.S. Pat. No. 5,233,954, which is incorporated herein by reference. However, the resulting surfaces, when intermeshing, resulted in undesirable gaps and/or surface interactions. Refinements were clearly desirable. The result is called the Doohovskoy Surface and optimizes the contact criteria between the meshing surfaces of the primary and secondary vanes and can be defined by a uniform procedure which is dependent on a small number of geometric parameters.

The Doohovskoy Surface is scalable and satisfies the needs of the TIVM. It minimizes clearances and gaps between the vanes, which increases sealing efficiency. It provides for uniform rotational motion of both the Secondary and Primary rotors, which minimizes vibration and noise and increases longevity. The Doohovskoy Surface is a “ruled” surface thereby making it manufacturable by a variety of well established methods including machining, molding, or casting. In addition, the meshing surfaces of the primary vanes and the secondary vanes share the same Doohovskoy Surface (although it is possible to use a specific surface for the primary vanes and another specific surface for the secondary vanes).

The rotating components of the Toroidal Intersecting Vane Machine (TIVM) are based on the geometry of a torus with embedded generalized cylinders. In this case, the term ‘embedded’ implies that the geometry of the cylinder is a function of the geometry of the torus. The toroidal geometry is used to define the primary rotor and primary vane dimensions. The embedded cylindrical geometry is used to define the secondary rotor and secondary vane dimensions. The number of cylinders, their dimension, and other particulars of their configuration within the torus are determined by optimization using the physical requirements of a particular application. Together, the toroidal and cylindrical geometry are used to solve for a meshing surface.

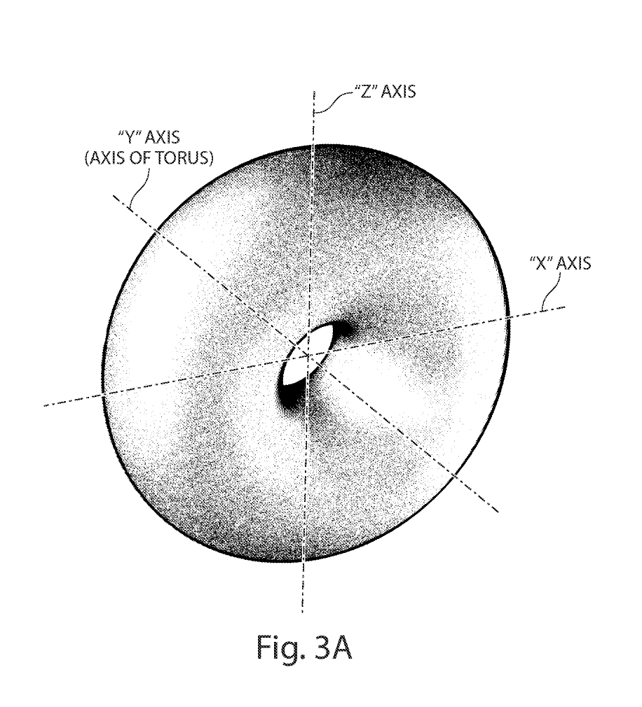

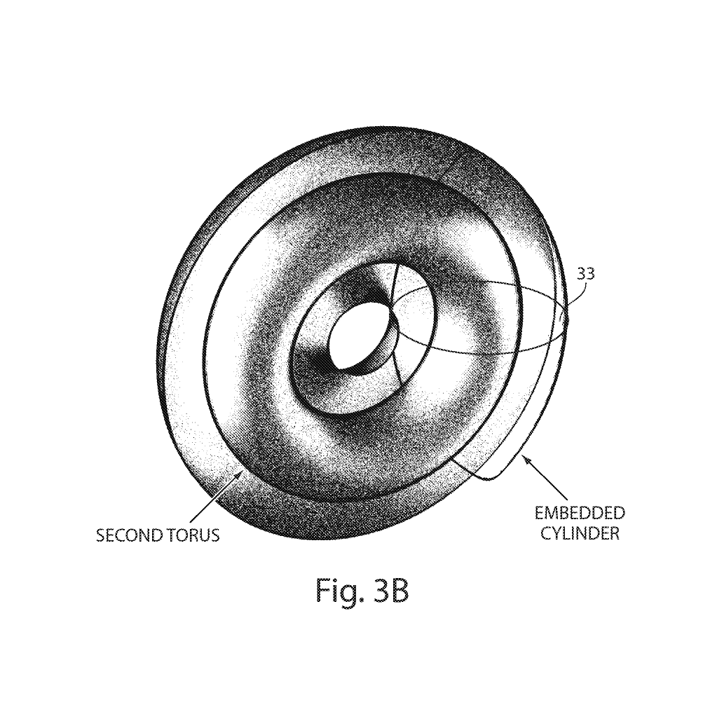

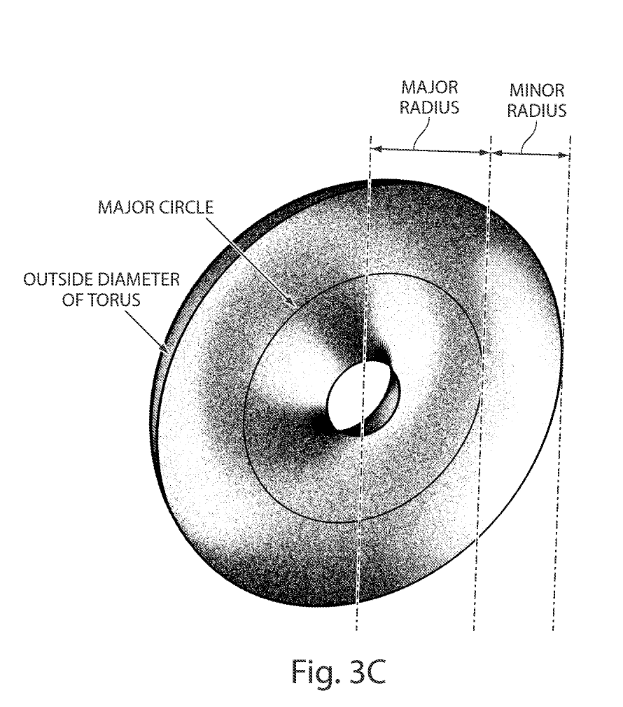

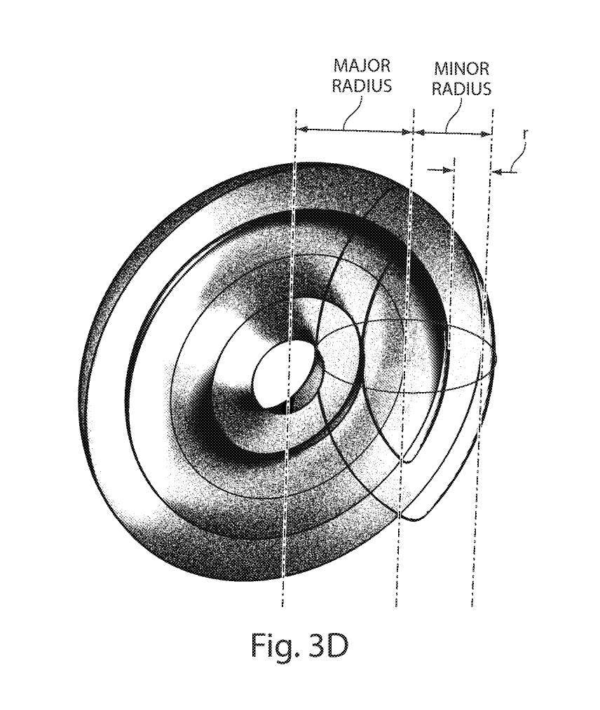

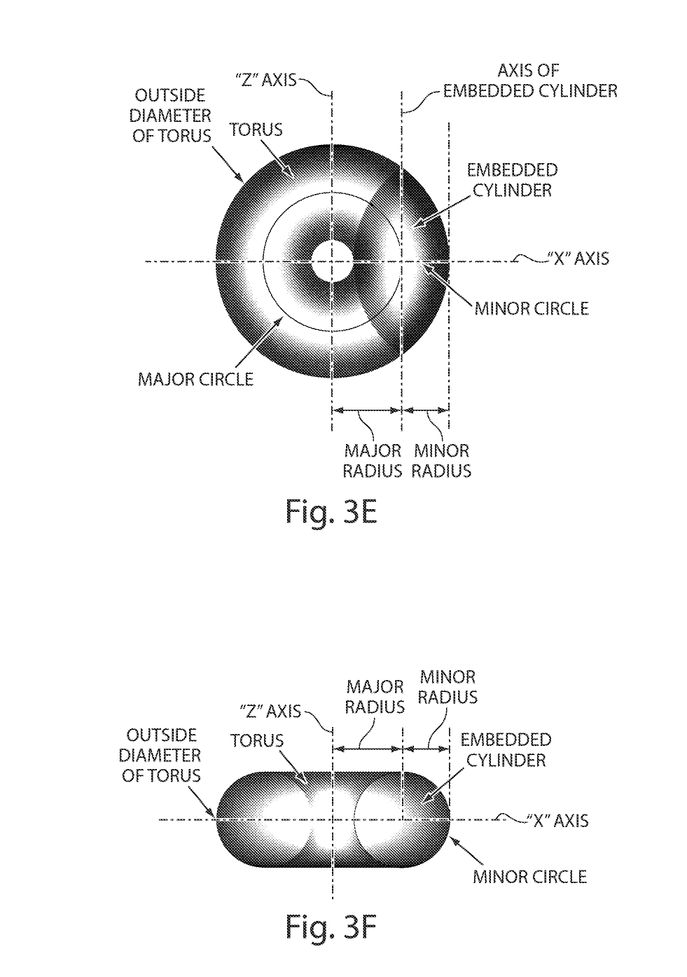

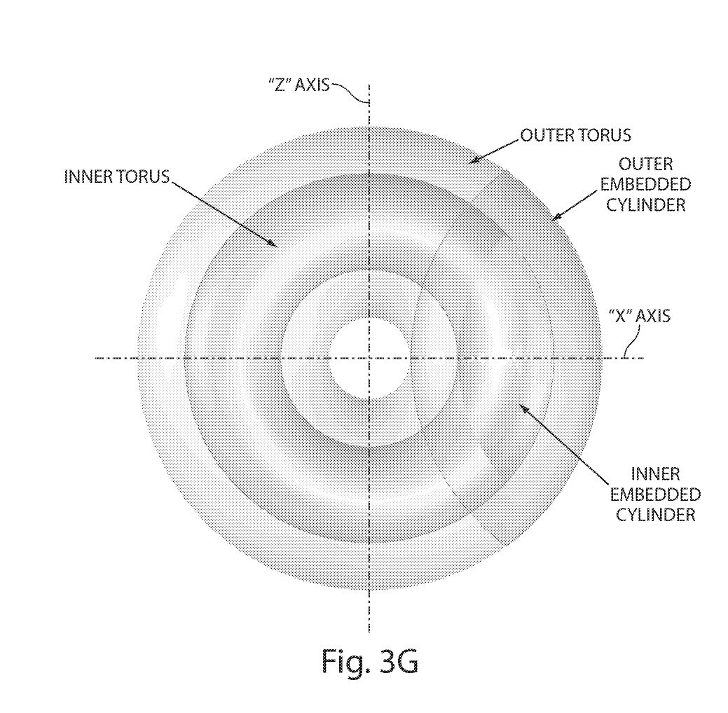

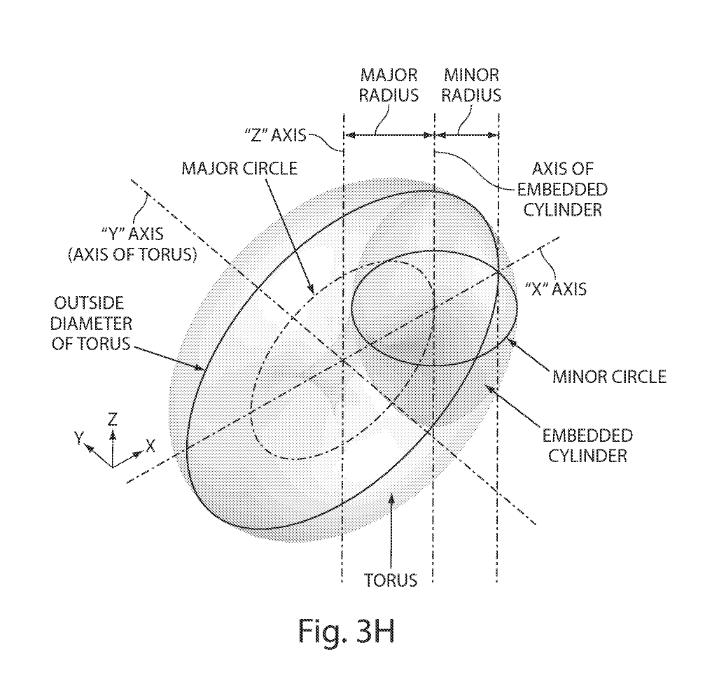

The geometric frame of reference for the torus and a single embedded cylinder is shown in FIG. 3A-3D. The torus under consideration is an ‘orthogonal’ torus and its frame of reference is a customary right-handed orthogonal system composed of X, Y, and Z axes.

FIG. 3A. In this representation, the primary axis of symmetry/rotation of the torus is the Y-axis with the torus itself laying parallel to, and bisected by, the ZX-plane. The secondary axis of symmetry/rotation for the cylinder is parallel to the Z-axis and goes through the center of a circle, called the Minor Circle, in the XY-plane with said circle being the intersection of the torus with the XY-plane (there are two such Minor Circles in the XY-plane). One such Minor Circle 33 is shown in FIG. 3B.

FIG. 3B also illustrates the second, or inner, torus that lies within the first, or outer, torus. The radius of the Minor Circle is called the Minor Radius.

FIG. 3C. The distance between the axis of rotation of the torus and the center of the Minor Circle is called the Major Radius. FIG. 3C. The torus is orthogonal because the Minor Circle lies in a plane which is parallel to the primary axis. The embedded cylinder is shown in FIG. 3B while FIG. 3D (side view), 3E (front view), 3F (cross-section), 3G (front view) and 3H (angled view) overlay the additional variables.

The problem began with the realization that it is largely dependent on two simultaneous rotations where:
MajRad=The Major Radius of the Torus.
MinRad=The Minor Radius of the Torus.
(θ)=Radians of Rotation in the ZX-plane, about the torus's axis of rotation.
(φ)=Radians of Rotation in the XY-plane, about the cylinder's axis of rotation.
   First Rotation in XY-plane:
   x₁=(MinRad cos(φ))+MajRad (0.1)
   y₁=MinRad sin(φ) (0.2)
   z₁=0.0 (0.3)
   Second Rotation in ZX-plane:
   x₂=x₁ sin(π/2+θ)=x₁(cos(θ)) (0.4)
   y₂=y₁ (0.5)
   z₂=x₁ cos(π/2+θ)=x₁(−sin(θ)) (0.6)
   Notice the use of (π/2) in equations (0.4) and (0.6). This is used to preserve the right-handedness of the coordinate system in that the +X-axis in the ZX-plane is equal to π/2 radians. Expanding the results in (0.4) through (0.6) gives:
   x=[MajRad+(MinRad(cos(φ))] cos(θ) (0.7)
   y=MinRad(sin(φ)) (0.8)
   z=[MajRad+(MinRad cos(φ))](−sin(θ)) (0.9)
   Given two radii, MajRad and MinRad, and two angles, φ and θ, the cartesian coordinates of any point located within the torus can be calculated with parametric equations (0.7) through (0.9) by varying ‘MinRad’ between 0.0 and its predetermined maximal value.

Accordingly, when the orders of the rotations are reversed, another set of equations evolves.

First Rotation in ZX-Plane:
x₁=(MajRad+MinRad)sin(π/2+θ)=(MajRad+MinRad)cos(θ) (0.10)
y₁=0.0 (0.11)
z₁=(MajRad+MinRad)cos(π/2+θ)=(MajRad+MinRad)(−sin(θ)) (0.12)
Second Rotation in XY-Plane
x₂=(x₁−MajRad)cos(φ)+MajRad (0.13)
y₂=(x₁−MajRad)sin(φ) (0.14)
z₂=z₁ (0.15)
The use of (π/2) in equations (0.10) and (0.12) is again used to preserve the right-handedness of the system. Expanding the results gives:
x=[((MajRad+MinRad)cos(θ)−MajRad)cos(φ)]+MajRad (0.16)
y=[((MajRad+MinRad)cos(θ)−MajRad] sin(φ) (0.17)
z=(MajRad+MinRad)(−sin(θ)) (0.18)
Given two radii, MajRad and MinRad, and two angles, φ and θ (also called phi and theta), the cartesian coordinates of any point located within the embedded cylinder can be calculated with parametric equations (0.16) through (0.18), again by varying ‘MinRad’ between 0.0 and a predetermined maximal value.

The initial conditions for each of the two systems of simultaneous rotations are identical. This system state is called ‘Phase-Zero’ and represents θ=φ=0. The Semi-Local Flow Method leverages this attribute. When equations (0.7) through (0.9) and (0.16) through (0.18) are evaluated at Phase-Zero, their identical results are:

| | | |
|---|---|---|
| (0.7′) x = MajRad + MinRad | | (0.16′) x = MajRad + MinRad |
| (0.8′) y = 0 | and, | (0.17′) y = 0 |
| (0.9′) z = 0 | | (0.18′) z = 0 |

Earlier attempts at designing meshing surfaces were centered around equations (0.16) through (0.18) by further constraining the value of φ in terms of θ by using an angular relationship in the same manner as a fixed gear ratio thereby imparting ‘motion’ constraints on the system. The gear ratio affects the angle of the helix generated by the rotations and is important to consider when optimizing various aspects of the TIVM.
(φ)=(θ)*GearRatio (0.19)
Unfortunately, this attempt was not successful and newer methods had to be developed to create pre-Doohovskoy Surfaces. These methods were numerical in nature and relied upon a brute force trial and error approach. The method was hit-or-miss and very time consuming, sometimes taking weeks or months of effort to design a single surface. This precluded iterating on the underlying toroidal geometry used in any particular application and made it very difficult to optimize designs or to change parameters mid-stream during a project. Even though the foundation of the two rotation systems was correct, the method was overly simplistic and lacked the necessary level of sophistication.

The Semi-Local Flow Method is exemplified here where the primary and secondary vanes are oriented perpendicular to each other, however, the rotor orientation can be skewed in the range defined between ‘parallel’ and ‘perpendicular’ orientations and surface solutions for these orientations made using the general methods described herein.

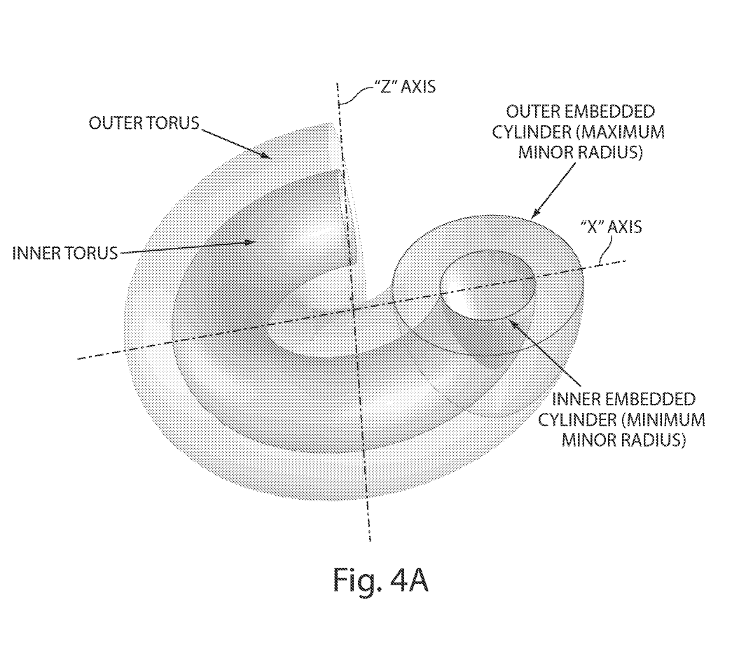

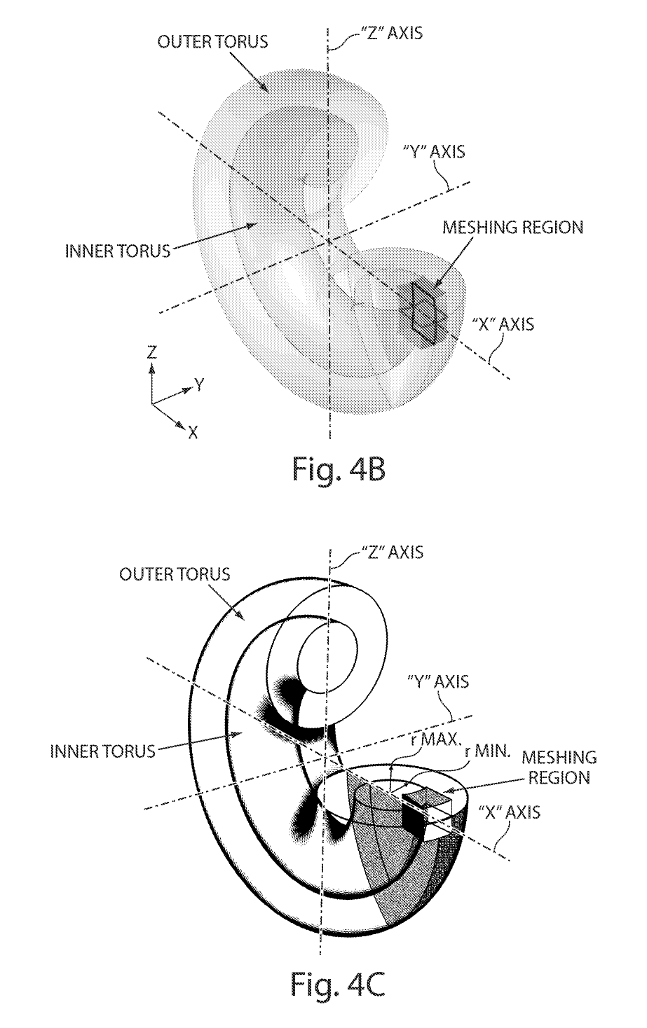

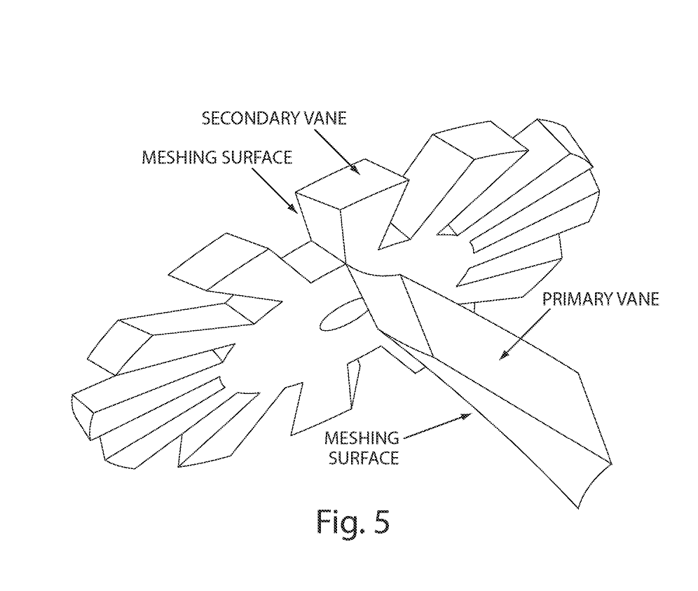

From the above discussion, it will be recognized that the primary and secondary vanes have intermeshing surfaces. The interactions of these surfaces will create a meshing region. FIG. 4A-4C provide views where a quarter of the torus is cutaway. FIG. 4A, for example, illustrates the inner torus and outer torus and the inner and outer cylinder. FIGS. 4B and 4C illustrate the meshing region of the primary and secondary vanes that follow these geometries. The inner torus of the geometric framework is clearly shown as well as the meshing region of the primary vane and secondary vane. FIG. 5 illustrates the first, or leading, meshing surface of the primary and the trailing meshing surface of the secondary vane at first touch of the meshing phase.

The desired intermeshing surface will have the form
Surf(t,r,tlimit)=(x(t,r),y(t,r),z(t,r))=(Surfx(t,r),Surfy(t,r),Surfz(t,r)),
where theta=ω1*t and phi=ω2*t,
−tlimit≦t≦+tlimit

and 0.0<MinValue≦r≦MinRad.

Primary and secondary vane surfaces will be defined by Surf(t, r, tlimit) for different values of tlimit.

We use this standard parametric definition of a surface Surf(t, r, tlimit) whose rectangular coordinates (Surfx(t,r), Surfy(t,r), Surfz(t,r) depend on the variable parameters (t,r) to determine points on the surface which also depends on other fixed constants such as the major radius, MajRad, and the limit bounds on the values of t and r, and on the angular velocities ω1 and ω2.

For such a surface, Surf, we now introduce a notation to describe the simultaneous rotational actions of a TIVM which bring the intermeshing surfaces of primary vanes and secondary vanes into tangential motion past one another in the meshing region shown in FIG. 4C. We will then define the qualitative properties of the intermeshing surface interaction in the context of TIVM operation.

When referring to the motion of the TIVM at phase s, we shall simply use the term “phase” or “phase s”. The motion of a primary vane surface will be defined by a toroidal action, Tor(s), of phase s:
PriVaneSurf(s,t,r)=Tor(s).Surf(t,r,tlimit 1)
The motion of a secondary vane surface will be defined by a cylindrical action, Cyl(s), of phase s:
SecVaneSurf(s,t,r)=Cyl(s).Surf(t,r,tlimit2).
The TIVM phase s is measured in radians.
We use PriVaneSurf(s) and SecVaneSurf(s) to denote all the rotated Surf points at phase s:
PriVaneSurf(s)={PriVaneSurf(s,t,r)|−tlimit1≦t≦+tlimit1 and 0.0<MinValue≦r≦MinRad}
and
SecVaneSurf(s)={SecVaneSurf(s,t,r)|−tlimit2≦t≦+tlimit2 and 0.0<MinValue≦r≦MinRad}
At phase zero, s=0, the action Tor(0)=1=Cyl(0)=the identity action, which results in:
PriVaneSurf(0,t,r)=Surf(t,r,tlimit1)≈Surf(t,r,tlimit2)=SecVaneSurf(0,t,r)
Or,
PriVaneSurf(0)≈SecVaneSurf(0)
This means that at phase zero, the primary vane surface and secondary vane surface are the same (congruent) except for different t limits. The ultimate goal of the Semi-Local Flow method is to extend this congruence to other phase values as well:
PriVaneSurf(s)˜SecVaneSurf(s)
In the case of nonzero phase, we cannot guarantee exact congruence, but can only minimize the distance between the surfaces when the phase s≠0.

The method first predicts the motion of a point, Surf(0,r,tlimit), at t=0 under the action of the TIVM. Since theta=ω1*t and phi=ω2*t, when t=0, we have both theta=0 and phi=0. Therefore,
P(0)=Surf(0,r,tlimit)=(MajRad+r,0,0)
is on a line segment which is on the intersection of the XY-plane with the XZ plane, i.e. on the X-axis. The method describes the motion of P(0) as it is rotated simultaneously by the action Tor(s) about the axis of the torus and by the action Cyl(s) about the perpendicular axis of the embedded cylinder.

Starting with the parametric equations for an orthogonal torus, (0.7) through (0.9), and its embedded cylinder, (0.16) through (0.18), a set of differential equations is developed which describe the two perpendicular motions of the primary and secondary vanes. The solution is then refined by introducing a number of indefinite coefficients into a Taylor series expansion of the solution to the differential equations. The coefficients can be further tuned to improve the gap performance. The method intrinsically produces a ruled surface with uniform kinematic qualities. A surface is a “ruled” surface if it can be generated by a moving straight line with the result that through every point on the surface a line can be drawn lying wholly in the surface. Thus, in one embodiment, the invention provides for a vane suitable for use in a TIVM characterized by a ruled intermeshing surface.

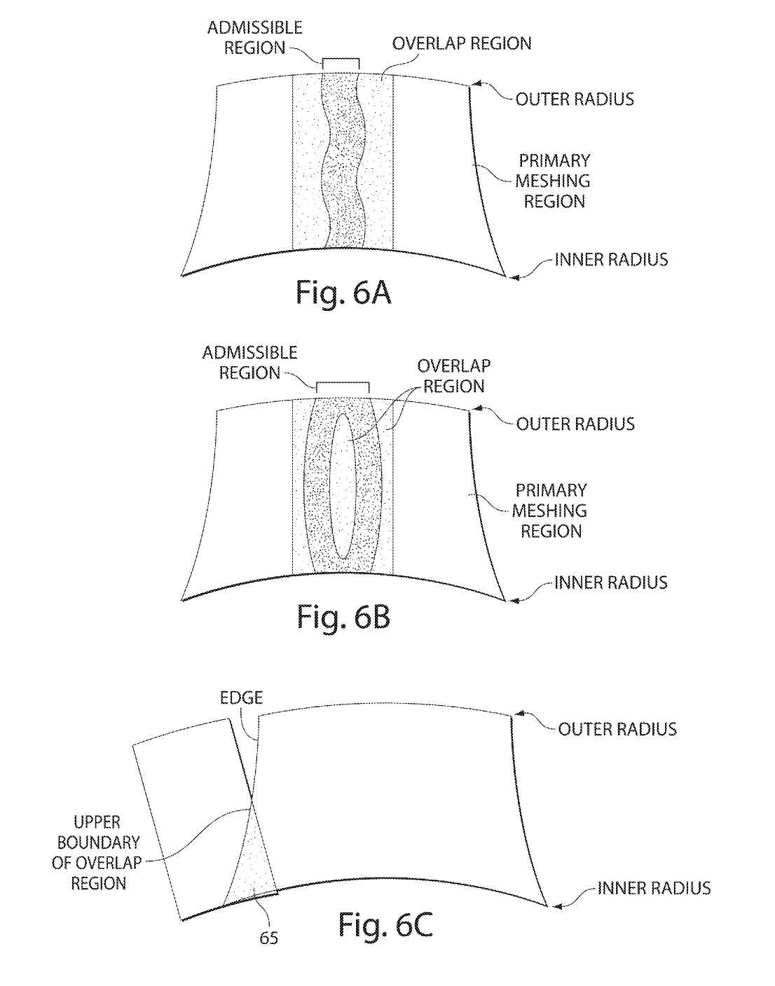

The quality of an intermeshing surface solution is evaluated by optimizing several measures of contact in the overlap region associated with the primary and secondary vane surfaces at various phases of the motion. As the two surfaces rotate, the area of the overlap region varies from 0 to some finite value. At a given phase s of the motion, the points of the overlap region, Overlap(s), are determined as follows. Let PriVaneSurf(s) be the primary vane surface at phase s. Let SecVaneSurf(s) be the secondary vane surface at phase s. A point p of the PriVaneSurf(s) is said to be in the overlap region PriOverlap(s) if the vector perpendicular to the tangent plane at p intersects SecVaneSurf(s); similarly, a point q of SecVaneSurf(s) is said to be in the overlap region SecOverlap(s) if the vector perpendicular to the tangent plane at q intersects PriVaneSurf(s). Overlap(s)=PriOverlap(s) u SecOverlap(s), that is the union of the points p and q as defined above. For a given phase s, a basic computation is the calculation of the distance, d(p(s), q(s)), between a given point in the overlap region of one surface (e.g., a point p(s) in PriOverlap(s), the overlap region in the intermeshing surface of the primary vane) and the closest point on the other surface (e.g., a point q(s) on the intermeshing surface of the secondary vane, SecVaneSurf(s) at phase s). The distance d(p(s), q(s)) is the ‘gap’ between the surfaces at a point p(s) in Overlap(s) at phase s of the motion of the machine. When a gap at a point is less than a specified maximal gap distance threshold, MaxGapDistance, the gap and the point at that phase of the motion are said to be ‘acceptable’. When all the points in a subset of the overlap region, Overlap(s), are acceptable, the area containing the points becomes ‘acceptable’ as well. When a connected, acceptable area extends continuously from the inner radius to the outer radius of the overlap region, the continuous area is called ‘admissible’ and shall be denoted by Admissible(s). FIG. 6A-6B illustrate the Overlap Region and Admissible Region on a vane. In this context, we can also refer to the Overlap Region 65 on a vane as the overlap region between, or common to, the intermeshing surfaces.

The tangential contact between the surfaces is optimized by maximizing the area of each admissible set, Admissible(s), as s varies from −MaxPhase through 0 to +MaxPhase, that is, the set of TIVM phases s when Overlap(s)≠Ø: We define InterMeshPhases={s|Overlap(s)≠Ø}={s|−MaxPhase≦s≦+MaxPhase} to be the set of phases when the overlap region is non-empty. An additional optimization statistic is the area of
∪{Admissible(s)|Overlap(s)≠Ø},
the union of all the admissible regions. The intermeshing phases, InterMeshPhases, begin with −MaxPhase, the first event of contact, between the intermeshing surface of the primary vane and the intermeshing surface of a secondary vane (see FIGS. 5 and 6C), and ending with +MaxPhase, the last event of contact between the intermeshing surface of the primary vane and the intermeshing surface of a secondary vane. The intermeshing surfaces of the primary and secondary vanes are those two surfaces that are “in contact,” or tangential, with each other at some phase of the motion. Given an initial geometric specification for a torus and its embedded generalized cylinder, the deformation coefficients are computed to achieve maximal admissible areas in every phase of the motion.

A surface solution, with suitably adjusted deformation coefficients, is admissible if at every phase s, of motion, the overlap region, Overlap(s), of the primary and secondary vanes contains a subset which is admissible. Preferably, an admissible surface solution has the property that during the intermeshing phase, at every phase of the motion, s, the tangential contact between admissible surfaces is tight enough over a connected area so that effectively there is little or no fluid flow in the 3-d volume between the primary and secondary vanes bounded by PriVaneOverlap(s) and SecVaneOverlap(s).

Thus, the invention provides for a TIVM with a primary and secondary vane each having an intermeshing surface wherein, at every phase s during the intermeshing phase, an overlap region, Overlap(s) defined above, consisting of points on the primary and secondary vanes, contains a connected area extending continuously from the inner radius to the outer radius of the vane in the overlap region characterized by a maximal gap distance of less than about 0.25 inches, preferably less than about 0.1 inches, more preferably less than about 0.001 inches, such as less than about 0.0001 inches. This improvement can also be considered as an improvement in reducing the gap size relative to the size of the vanes. In this embodiment, the invention includes a TIVM with a primary and secondary vane each having an intermeshing surface wherein, at every phase s during the intermeshing phase, an overlap region, Overlap(s) defined above, consisting of points on the primary and secondary vanes, contains a connected area extending continuously from the inner radius to the outer radius of the overlap characterized by a maximal gap distance of less than about 10% of the radial height of the primary vane, preferably less than about 1%, more preferably less than about 0.1%, such as less than about 0.01%.

At first contact, s=−MaxPhase and at last contact, s=+MaxPhase. At these “extreme” points of the phase, the overlap region consists of either a point or a line and therefore at these extreme points the area of the overlap region is zero. For this special case, if the overlap region consists of a single point and that point is admissible, then 100% of the overlap region is admissible. Similarly, if the overlap region consists of a single line, then an admissible subset must extend from the inner to the outer radial distance along the line, i.e., if an admissible subset exists it must be the whole line. When the area of the overlap region is nonzero, we can measure the quality of our surface solution by the fraction of the overlap region which is admissible. Thus, at a given phase s, the area of Admissible(s) can be at least about 1%, preferably at least about 5% more preferably at least about 20% of the area of Overlap(s), the overlap region at phase s. In one embodiment, the admissible surface, Admissible(s), can be at least about 50%, such as at least about 90% of the area of Overlap(s), the overlap region.

Further, the improvement can extend to the entire surface during the intermeshing phase. The invention provides for a TIVM with a primary and secondary vane each having an intermeshing surface wherein the intermeshing surfaces, during the intermeshing phase, are characterized by a maximal gap distance of less than about 0.25 inches, preferably less than about 0.1 inches, more preferably less than about 0.001 inches, such as less than about 0.0001 inches. Thus, the invention provides for a TIVM with a primary and secondary vane each having an intermeshing surface wherein the intermeshing surfaces, during the intermeshing phase, are characterized by a maximal gap distance of less than about 10% of the height of the primary vane, preferably less than about 1%, more preferably less than about 0.1%, such as less than about 0.01%.

In a preferred embodiment, the surface solution of the intermeshing surface for the primary vane is the same, or substantially the same, as the surface solution of the intermeshing surface for the secondary vane. Indeed, in a more preferred embodiment, both the leading and trailing surfaces of each vane possess the same surface solution.

FIGS. 4B and 4C illustrate a sample of the inner and outer limits of the region wherein the primary and secondary vanes intermesh, or interact and illustrate further constraints by applying bounding angles in terms of the torus and the cylinder so that the region is more fully defined and enclosed. It is within this region that the surface solution is optimized and tested for admissibility.

The differential equations which describe the resultant dynamics of the two perpendicular motions are obtained by computing the first derivative of the rotation operators for the torus and the embedded generalized cylinder. These derivatives, acting locally at a point, give velocity vectors which are added to give a resultant velocity vector which is equivalent to a system of differential equations with constant coefficients. These steps are described in detail below, using a convention of applying matrices from the left (premultiplication of matrices). We refer to this approach as the Semi-Local Flow (SLF) Method.

The matrices we use below are elements of a 4-dimensional representation of SE(3), the Special Euclidean group of all 3-dimensional proper rigid-body motions. These matrices act on 4-dimensional vectors which represent and correspond to points in 3-dimensional Euclidean space.

Let matrix [A], utilizing parametric equations (0.7) through (0.9), represent the rotation matrix for any point within the torus rotated in the ZX-plane.

$$[ A ] = [ \begin{matrix}cos ( t * {ω}_{1} ) & 0 & sin ( t * {ω}_{1} ) & 0 \\ 0 & 1 & 0 & 0 \\ - sin ( t * {ω}_{1} ) & 0 & cos ( t * {ω}_{1} ) & 0 \\ 0 & 0 & 0 & 1\end{matrix} ] \qquad ( 0.20 )$$

(t*ω₁)=θ, radians of rotation in the ZX-plane. (0.21)
The matrix [A] describes the action Tor(s), where the TIVM phase s=t*ω1.

Let matrix [B], utilizing parametric equations (0.16) through (0.18), represent the rotation matrix for any point within the embedded cylinder rotated about an axis translated from the global origin to the Major Radius and perpendicular to the XY plane.
(0.22)

$$[ B ] = [ \begin{matrix}cos ( t * {ω}_{2} ) & - sin ( t * {ω}_{2} ) & 0 & MajRad - \\ & & & MajRad ( cos ( t * {ω}_{2} ) ) \\ sin ( t * {ω}_{2} ) & cos ( t * {ω}_{2} ) & 0 & - MajRad ( sin ( t * {ω}_{2} ) ) \\ 0 & 0 & 1 & 0 \\ 0 & 0 & 0 & 1\end{matrix} ] \qquad ( 0.22 )$$

(t*ω₂)=φ, radians of rotation in the XY-plane. (0.23)
The matrix [B] describes the action Cyl(s), where the dependence on the TIVM phase s is through the GearRatio.

The constants ω₁ and ω₂, in equations (0.21) and (0.23) respectively, perform two functions: the sign of each constant determines the direction of rotation (positive=counterclockwise, negative=clockwise) with respect to a right-handed coordinate system, and the absolute value of the quotient of the two constants represents the gear ratio, thus imparting the motion constraints to the system.
ω₂/ω₁|=GearRatio. (0.24)

Let matrix Dₜ[A] represent the first derivative of matrix [A] with respect to ‘t’.

$${D}_{t} [ A ] = [ \begin{matrix}- {ω}_{1} ( sin ( t * {ω}_{1} ) ) & 0 & {ω}_{1} ( cos ( t * {ω}_{1} ) ) & 0 \\ 0 & 0 & 0 & 0 \\ - {ω}_{1} ( cos ( t * {ω}_{1} ) ) & 0 & - {ω}_{1} ( sin ( t * {ω}_{1} ) ) & 0 \\ 0 & 0 & 0 & 0\end{matrix} ] \qquad ( 0.25 )$$

And let Dₜ[B] represent the first derivative of matrix [B], also with respect to t.
(0.26)

$${D}_{t} [ B ] = [ \begin{matrix}- {ω}_{2} ( sin ( t * {ω}_{2} ) ) & - {ω}_{2} ( cos ( t * {ω}_{2} ) ) & 0 & MajRad \\ & & & {ω}_{2} ( sin ( t * {ω}_{2} ) ) \\ {ω}_{2} ( cos ( t * {ω}_{2} ) ) & - {ω}_{2} ( sin ( t * {ω}_{2} ) ) & 0 & - MajRad \\ & & & {ω}_{2} ( cos ( t * {ω}_{2} ) ) \\ 0 & 0 & 0 & 0 \\ 0 & 0 & 0 & 0\end{matrix} ] \qquad ( 0.26 )$$

The next step is to evaluate (0.25) and (0.26) at t=0,

$$\begin{matrix}{{D}_{t} [ A ]}_{t = 0} = [ \begin{matrix}0 & 0 & {ω}_{1} & 0 \\ 0 & 0 & 0 & 0 \\ - {ω}_{1} & 0 & 0 & 0 \\ 0 & 0 & 0 & 0\end{matrix} ] & ( 0.27 ) \\ {{D}_{t} [ B ]}_{t = 0} = [ \begin{matrix}0 & - {ω}_{2} & 0 & 0 \\ {ω}_{2} & 0 & 0 & - MajRad {ω}_{2} \\ 0 & 0 & 0 & 0 \\ 0 & 0 & 0 & 0\end{matrix} ] & ( 0.28 )\end{matrix}$$

and then add the two matrices together resulting in matrix [V₀]:

$$[ {V}_{0} ] = {( {D}_{t} [ A ] + {D}_{t} [ B ] )}_{t = 0} = [ \begin{matrix}0 & - {ω}_{2} & {ω}_{1} & 0 \\ {ω}_{2} & 0 & 0 & - MajRad {ω}_{2} \\ - {ω}_{1} & 0 & 0 & 0 \\ 0 & 0 & 0 & 0\end{matrix} ] . \qquad ( 0.29 )$$

A linear system of differential equations of the form D U̅/dt=V₀* U̅, where U̅ is a point along the path of motion being sought, has now been formed. The matrix differential equation has the formal exponential solution U̅(t)=exp(t*V₀)* U̅(0); the equivalent linear system can be solved directly as follows. Let

$$\begin{matrix}[ \overline{U} ( t ) ] = [ \begin{matrix}x ( t ) \\ y ( t ) \\ z ( t ) \\ 1\end{matrix} ] & ( 0.30 ) \\ [ {V}_{0} ] [ \overline{U} ( t ) ] = [ \begin{matrix}z ( t ) {ω}_{1} - y ( t ) {ω}_{2} \\ x ( t ) {ω}_{2} - ( MajRad {ω}_{2} ) \\ - x ( t ) {ω}_{1} \\ 1\end{matrix} ] & ( 0.31 )\end{matrix}$$

resulting in the following differential equations:
xₜ(t)=z(t)ω₁−y(t)ω₂
yₜ(t)=x(t)ω₂−(MajRadω₂)
zₜ(t)=−x(t)ω₁ (0.32)
The solution to these differential equations is:

$$\begin{matrix}x ( t ) = \frac{( z ( 0 ) {ω}_{1} - y ( 0 ) {ω}_{2} ) sin ( t \sqrt{{ω}_{1}^{2} + {ω}_{2}^{2}} )}{\sqrt{{ω}_{1}^{2} + {ω}_{2}^{2}}} - \frac{( ( MajRad - x ( 0 ) ) {ω}_{2}^{2} - x ( 0 ) {ω}_{1}^{2} ) cos ( t \sqrt{{ω}_{1}^{2} + {ω}_{2}^{2}} )}{{ω}_{1}^{2} + {ω}_{2}^{2}} + \frac{MajRad {ω}_{2}^{2}}{{ω}_{1}^{2} + {ω}_{2}^{2}} & ( 0.33 ) \\ y ( t ) = - \frac{( ( MajRad - x ( 0 ) ) {ω}_{2}^{3} - x ( 0 ) {ω}_{1}^{2} {ω}_{2} ) sin ( t \sqrt{{ω}_{1}^{2} + {ω}_{2}^{2}} )}{{( {ω}_{1}^{2} + {ω}_{2}^{2} )}^{3 / 2}} + \frac{( y ( 0 ) {ω}_{2}^{2} - z ( 0 ) {ω}_{1} {ω}_{2} ) cos ( t \sqrt{{ω}_{1}^{2} + {ω}_{2}^{2}} )}{{ω}_{1}^{2} + {ω}_{2}^{2}} + \frac{z ( 0 ) {ω}_{1} {ω}_{2} + y ( 0 ) {ω}_{1}^{2}}{{ω}_{1}^{2} + {ω}_{2}^{2}} - \frac{MajRad t {ω}_{1}^{2} {ω}_{2}}{{ω}_{1}^{2} + {ω}_{2}^{2}} & ( 0.34 ) \\ z ( t ) = \frac{( ( MajRad - x ( 0 ) ) {ω}_{1} {ω}_{2}^{2} - x ( 0 ) {ω}_{1}^{3} ) sin ( t \sqrt{{ω}_{1}^{2} + {ω}_{2}^{2}} )}{{( {ω}_{1}^{2} + {ω}_{2}^{2} )}^{3 / 2}} - \frac{( y ( 0 ) {ω}_{1} {ω}_{2} - z ( 0 ) {ω}_{1}^{2} ) cos ( t \sqrt{{ω}_{1}^{2} + {ω}_{2}^{2}} )}{{ω}_{1}^{2} + {ω}_{2}^{2}} + \frac{z ( 0 ) {ω}_{2}^{2} + y ( 0 ) {ω}_{1} {ω}_{2}}{{ω}_{1}^{2} + {ω}_{2}^{2}} - \frac{MajRad t {ω}_{1} {ω}_{2}^{2}}{{ω}_{1}^{2} + {ω}_{2}^{2}} & ( 0.35 )\end{matrix}$$

When initial conditions are imposed at Phase-Zero, the solution to the differential equations can be simplified. Recall that at Phase-Zero, the initial conditions for both systems of rotations is:
x(0)=MajRad+r
y(0)=0.0
z(0)=0.0 (0.36)
where the variable r varies according to: 0.0<MinValue≦r≦MinRad. MinValue is a fixed minimum value for the variable r.
Through substitution of (0.36), the simplified solutions to equations (0.33) through (0.35) are:

$$\begin{matrix}x ( t , r ) = \frac{MajRad {ω}_{2}^{2}}{{ω}_{1}^{2} + {ω}_{2}^{2}} - \frac{( - r {ω}_{2}^{2} - ( MajRad + r ) {ω}_{1}^{2} ) cos ( t \sqrt{{ω}_{1}^{2} + {ω}_{2}^{2}} )}{{ω}_{1}^{2} + {ω}_{2}^{2}} & ( 0.37 ) \\ y ( t , r ) = - \frac{( - r {ω}_{2}^{3} - ( MajRad + r ) {ω}_{1}^{2} {ω}_{2} ) sin ( t \sqrt{{ω}_{1}^{2} + {ω}_{2}^{2}} )}{{( {ω}_{1}^{2} + {ω}_{2}^{2} )}^{3 / 2}} - \frac{MajRad t {ω}_{1}^{2} {ω}_{2}}{{ω}_{1}^{2} + {ω}_{2}^{2}} & ( 0.38 ) \\ z ( t , r ) = \frac{( - r {ω}_{1} {ω}_{2}^{2} - ( MajRad + r ) {ω}_{1}^{3} ) sin ( t \sqrt{{ω}_{1}^{2} + {ω}_{2}^{2}} )}{{( {ω}_{1}^{2} + {ω}_{2}^{2} )}^{3 / 2}} - \frac{MajRad t {ω}_{1} {ω}_{2}^{2}}{{ω}_{1}^{2} + {ω}_{2}^{2}} & ( 0.39 )\end{matrix}$$

A Taylor expansion of equations (0.37) through (0.39) to the 3^{rd} order in ‘t’ in the neighborhood of t=0 results in the following motion equations:

$$\begin{matrix}x ( t , r ) = - \frac{( MajRad {ω}_{1}^{2} + r ( {ω}_{2}^{2} + {ω}_{1}^{2} ) ) {t}^{2} - 2 MajRad - 2 r}{2} & ( 0.40 ) \\ y ( t , r ) = - {ω}_{2} \frac{( MajRad {ω}_{1}^{2} + r ( {ω}_{2}^{2} + {ω}_{1}^{2} ) ) {t}^{3} - ( 6 r t )}{6} & ( 0.41 ) \\ z ( t , r ) = {ω}_{1} \frac{( ( MajRad {ω}_{1}^{2} ) + r ( {ω}_{2}^{2} + {ω}_{1}^{2} ) ) {t}^{3} + ( - 6 MajRad - 6 r ) t}{6} & ( 0.42 )\end{matrix}$$

Equations (0.40) through (0.42) model the motion of any point, starting at Phase-Zero, which undergoes simultaneous rotations in the torus and embedded cylinder. To go from ‘motion’ to ‘surface’, the sign of ω₂ is negated; changing the sign of ω₂ in the above equations effectively changes the sign of the y-component as shown in the following surface equations:

$$\begin{matrix}Surf {0}_{x} ( t , r ) = - \frac{( MajRad {ω}_{1}^{2} + r ( {ω}_{2}^{2} + {ω}_{1}^{2} ) ) {t}^{2}}{2} + MajRad + r & ( 0.43 ) \\ Surf {0}_{y} ( t , r ) = {ω}_{2} \frac{( MajRad {ω}_{1}^{2} + r ( {ω}_{2}^{2} + {ω}_{1}^{2} ) ) {t}^{3}}{6} + r {ω}_{2} t & ( 0.44 ) \\ Surf {0}_{z} ( t , r ) = {ω}_{1} \frac{( MajRad {ω}_{1}^{2} + r ( {ω}_{2}^{2} + {ω}_{1}^{2} ) ) {t}^{3}}{6} - ( MajRad + r ) {ω}_{1} t & ( 0.45 )\end{matrix}$$

Equations (0.43) through (0.45) produce a ruled algebraic surface which is linear in the variable r (the quantities MajRad, ω₁, ω₂ are constant); in the next step, the Semi-Local Flow method introduces deformation parameters, in the form of coefficients, to gain control over the tangential contact characteristics of the surfaces.

$$\begin{matrix}{Surf}_{x} ( t , r ) = - \frac{{c}_{x 1} ( MajRad {ω}_{1}^{2} + r ( {ω}_{2}^{2} + {ω}_{1}^{2} ) ) {t}^{2}}{2} + MajRad + r & ( 0.46 ) \\ {Surf}_{y} ( t , r ) = {ω}_{2} \frac{{c}_{y 2} ( MajRad {ω}_{1}^{2} + r ( {ω}_{2}^{2} + {ω}_{1}^{2} ) ) {t}^{3}}{6} - {c}_{y 1} r {ω}_{2} t & ( 0.47 ) \\ {Surf}_{z} ( t , r ) = {ω}_{1} \frac{{c}_{z 2} ( MajRad {ω}_{1}^{2} + r ( {ω}_{2}^{2} + {ω}_{1}^{2} ) ) {t}^{3}}{6} - {c}_{z 1} ( MajRad + r ) {ω}_{1} t & ( 0.48 )\end{matrix}$$

The deformation parameters (cₓ₁,c_{y1}, c_{y2}, c_{z1}, c_{z2}) are determined by optimizing the criteria which measure the closeness of the contact between the primary and secondary vanes. Several measures of optimality can be used, but the principal criterion is to maximize the area of admissible regions in all phases of the overlap interaction between the primary and secondary vane surfaces.

In the case of the perpendicular rotations, one straightforward solution for the deformation parameters specializes to the case (1,1,c_{y2},1,1) which leads to the following expressions for the surface solution:

$$\begin{matrix}{Surf}_{x} ( t , r ) = - \frac{( MajRad {ω}_{1}^{2} + r ( {ω}_{2}^{2} + {ω}_{1}^{2} ) ) {t}^{2}}{2} + MajRad + r & ( 0.49 ) \\ {Surf}_{y} ( t , r ) = {ω}_{2} \frac{{c}_{y 2} ( MajRad {ω}_{1}^{2} + r ( {ω}_{2}^{2} + {ω}_{1}^{2} ) ) {t}^{3}}{6} - r {ω}_{2} t & ( 0.50 ) \\ {Surf}_{z} ( t , r ) = {ω}_{1} \frac{( MajRad {ω}_{1}^{2} + r ( {ω}_{2}^{2} + {ω}_{1}^{2} ) ) {t}^{3}}{6} - ( MajRad + r ) {ω}_{1} t & ( 0.51 )\end{matrix}$$

Given a geometric configuration with design values for ω₁, ω₂, MajRad, the deformation parameter c_{y2} is determined by an optimization procedure which maximizes admissible regions at every phase of motion. For example, good to excellent results have been obtained employing a value of 0.2 and 0.22. Those practiced in the art can find suitable values absent undue experimentation.

Provided with the above method, alternative methodologies, reparameterizations and solutions for the interaction between a toroid (or other shape, such as a sphere) and a cylinder can be designed. One such solution is depicted by the following formulae, also developed by the present inventor:
Surfₓ(t,r)=cos(tω₁)(((MajRad+r)cos(tω₁)−MajRad)cos(tω₂)+MajRad) (0.52)
Surf_{y}(t,r)=−((MajRad+r)cos(tω₁)−MajRad)sin(tω₂) (0.53)
Surf_{z}(t,r)=sin(tω₁)(((MajRad+r)cos(tω₁)−MajRad)cos(tω₂)+MajRad) (0.54)

The Semi-Local Flow Method enables the design of vanes with a surface that is characterized by Equations 0.49, 0.50 and 0.51. Further, minor changes or approximations of the surface can be designed as well. Thus, the invention relates to a vane adapted for use in a toroidal intersecting vane machine characterized by one or two surfaces which are ruled surfaces. Preferably, the surfaces are leading and/or trailing surfaces of the vane, when the vanes are affixed to a toroidal intersecting vane machine. In one embodiment, the surface is approximated by Equations 0.49, 0.50 and 0.51. A surface can be said to be “approximated” by these equations if the points of a substantial amount of the surface (e.g., at least about 70%, such as at least about 80%, preferably at least about 90%, more preferably at least about 95%) have coordinates which are, independently, within 10% (preferably within 5%) of the theoretical value. Preferably, the coordinates of each point of the surface is characterized by Equations 0.49, 0.50 and 0.51.

Alternatively, or additionally, the invention relates to a vane pair comprising a primary vane and a secondary vane each characterized by at least one, preferably two, ruled surfaces. Preferably, the surfaces are leading and/or trailing surfaces of the vane, when the vanes are affixed to a toroidal intersecting vane machine. Each such surface is preferably characterized by the same surface solution. In one embodiment, each such surface is approximated by Equations 0.49, 0.50 and 0.51. Preferably, each surface is characterized by Equations 0.49, 0.50 and 0.51.

Alternatively or additionally, the invention relates to a vane or vane pair, characterized by surface solutions such that, when the vanes are affixed to rotors in a toroidal intersecting vane machine, and during each intermeshing phase, the overlap area between the primary and secondary vanes contains an area subset which is admissible. Preferably, an admissible surface solution has the property that at every phase of the motion, the tangential contact between admissible surfaces is tight enough over a connected area so that effectively there is little or no fluid flow between the primary and secondary vanes.

The vanes of the present invention can be used in other toroidal intersecting machines, such as a gear set comprising an outer toroidal gear and an internal cylindrical gear. A TIVM is preferred.

Specifically, it is an object of the invention to provide a toroidal intersecting vane machine, including but not limited to a toroidal self-synchronized intersecting vane machine, that greatly reduces the frictional losses through meshing surfaces without the need for external gearing. This is accomplished by optimizing the surfaces of the vanes. Thus, the invention includes an intersecting vane machine comprising a supporting structure having an inside surface, a first rotor and at least one intersecting second rotor, preferably a plurality of secondary rotors, rotatably mounted in said supporting structure, wherein:

(a) said first rotor has a plurality of primary vanes positioned on a radially inner peripheral surface of said first rotor, with spaces between said primary vanes and said inside surface of said supporting structure defining a plurality of primary chambers;

(b) an intake port which permits flow of a fluid into said primary chamber and an exhaust port which permits exhaust of the fluid out of said primary chamber;

(c) said second rotor has a plurality of secondary vanes positioned on a radially outer peripheral surface of said second rotor, with spaces between said secondary vanes and said inside surface of said supporting structure defining a plurality of secondary chambers;

(d) a first axis of rotation of said first rotor and a second axis of rotation of said second rotor arranged so that said axes of rotation do not intersect, said first rotor, said second rotor, primary vanes and secondary vanes being arranged so that said primary vanes and said secondary vanes (or abutments) intersect at only one location during their rotation; and

(e) wherein the secondary vanes positively displace the primary chambers and pressurize the fluid in the primary chambers and the leading and trailing surfaces of the vanes possess the characteristics described above.

In one embodiment, the secondary rotors are radially positioned about said first axis of rotation of said first rotor. The supporting structure conveniently comprises a plurality of wedge-shaped sectors, with the secondary rotors being encapsulated between adjacent sectors. The sectors can be the same size or different and can encapsulate a second rotor or not. The sectors, when combined, complete the circular plane parallel to the plane of rotation created by the first rotor. That is, the sum of the angles defining each wedge is 360 degrees. This configuration permits an easily adjustable machine having variability in flow rates, pressure differentials, etc.

Thus, the distance between each of the secondary rotors (or each pair of the rotors) can be the same or different. In one embodiment, the distance between at least two of the secondary rotors at the point of intersection with said first rotor is less than the length of said primary vane and/or chamber. This configuration allows the volume of the primary chamber, as filled by the intake port, to be less than the volume of the chamber when it completely clears the secondary vane. In another embodiment, the distance between at least two of the secondary rotors at the point of intersection with said rotor is greater than the length of said primary vane and/or chamber. This maximizes the amount of fluid that can be introduced into the primary chamber. In yet another embodiment, combinations of these configurations can be included.

Because the primary and secondary rotors intersect, the paths of travel (or tracks) of the primary and secondary vanes intersect. The exhaust port can be located proximal to the point of intersection. Alternatively, the exhaust port can be located distally to the point of intersection. In one embodiment, the exhaust port can be along the path of travel of the secondary vanes. Further, the intake port can be located proximally to the point of intersection of the primary vanes and secondary vanes or the point of intersection of the paths of travel. Where the exhaust ports and intake ports are located at each point of intersection, the exhaust port can come into contact with a traveling primary vane before the primary vane comes into contact with the intake port. The exhaust ports are preferably not in fluid communication with the intake ports.

The machine can be configured as a compressor, a pump, an expander or combinations thereof. It can include an external input power supply connected to drive the first and/or secondary rotors or it can include an external output power user. It can also be configured as an internal combustion engine.

In one embodiment, a leading surface, or edge, of a vane of one rotor drives the trailing surface, or edge, of a vane of another rotor or abutment, with the spacing of the vanes such that they are geometrically synchronized, thereby eliminating the use of an external gear train. For example, the leading surfaces of at least two consecutive primary vanes are in contact with the trailing surfaces of at least two consecutive secondary vanes. The embodiment relies upon the inherent design of the intersecting vane mechanism to provide related duties. The elimination of the extra apparatus for an external gear train thereby results in savings in complexity and cost.

In one embodiment, a self-synchronized toroidal intersecting vane machine is configured as a compressor, pump or expander or combination thereof where an external means for supplying initial input power is connected to a central shaft connect to said first or secondary rotors.

The machine can have a wide range of gear ratios. In one embodiment, the secondary rotors have a number of said secondary vanes equal to (number of said primary vanes on said first rotor) divided by the (GEAR RATIO), where GEAR RATIO equals revolutions of each of said secondary rotors per revolution of said first rotor. Preferably, the gear ratio is at least 1:1, preferably at least 1.5:1, and more preferably about 2:1.

Further, the machine can accommodate a large range of fluid flow rates and/or rotational speeds for each rotor. Of course, the fluid flow rate will be dependent upon the volume of each chamber and the rotational speed of the rotors. For example, the fluid flow rate can be greater than 0.005 cubic feet per minute (CFM), such as at least about 30 CFM, preferably at least about 250 CFM, or at least about 1000 CFM. Generally, the fluid flow rate will be less than 5 million CFM. The rotational speed of the rotors can also be varied widely. For example, the first rotor can rotate at a rate of less than 1 revolution per minute (RPM). However, it will generally rotate at much higher speeds, such as at least about 500 RPMs, preferably at least about 1000 RPMs, more preferably at least about 1500 RPMs. Similarly, the secondary rotors can rotate at a rate of less than 1 rotation per minute (RPM). However, they will generally rotate at much higher speeds, such as at least about 500 RPMs, preferably at least about 1000 RPMs, more preferably at least about 2000 RPMs.

In one embodiment, the total flow rate of fluid through the primary chambers can be at least 250 cubic feet per minute with a primary speed of said first rotor of at least 1700 rotations per minute. In one embodiment, the speed of said secondary rotors can be at least 3000 rotations per minute. In this preferred configuration, the ratio of the axial width of said secondary vanes to the axial width of said primary vanes can be less than 1:1, preferably less than 0.5:1. The primary chamber volume can be at least about 0.75 cubic inches, preferably at least about 1.5 cubic inches, more preferably about 2 cubic inches, and/or the secondary chamber volume can be less than about 0.5 cubic inches.

In another embodiment, the porting configuration is reversed, as compared to the above. Thus, the secondary chambers are ported, allowing pressurization of the secondary chambers, and the primary chambers are not ported and are not pressurized.

In one embodiment, the invention is a self-synchronized toroidal intersecting vane machine. The invention has two or more rotors rotatably mounted within a supporting structure so that the vanes of each of the rotors pass through a common region or intersection. Between the vanes of each primary rotor exists chambers which contain and exchange a working fluid. Changes in volume of the chambers are made possible by the interaction of the vanes. Because the rotors and their vanes continuously rotate, they create a cyclic positive displacement pumping action which enables the processing of a working fluid, such as a pump, compressor or expander. If heat is added to the process then the machine can be used as an engine. If heat is removed from the process then the machine can be used as a refrigeration device.

The invention may be used, for example, in the machines and engines described in U.S. Pat. No. 5,233,854, which is incorporated herein by reference.

Technological Uses and Applications

The present invention finds uses as either a compressor or expander or in some instances where multiple machines are used in a single application, as both. The present invention may operate to expand or compress any number of working fluids. As used herein the term “working fluid” includes any substance acting as a fluid as that term is used in the art. Working fluids may comprise air, water (including all phases of water), multiphase hydrocarbons, fuels, flowable gases, compressible gases, mixtures and the like.

In these uses it is expected that the market entry device could take many forms. These include, but are not limited to single compressor or expander systems as well as multi-component arrays. The power rating on these systems may vary and includes systems having a capacity of 1-5 MW, 5-10 MW, 10-50 MW, 10-20 kW, 20-40 MW, 5-10 kW, 20-50 kW, 50-100 kW, 500-1000 kW or 100-500 kW.

The present invention has many applications. Broadly, the present invention may also be used in compression, power generation, as well as power recovery. The present invention finds use in many commercial process applications, including in the automotive industry, refrigeration, applications and the like detailed herein.

It will be understood that applications recited herein are not exhaustive and not meant to be limited solely as categorized. As such, any one or more uses of the present invention, as either a compressor or expander, as single or multi-stage, may be combined to address the particular problem.

Power Generation

When used as a compressor, the invention may derive motive power or force from many sources including natural and artificial inputs. Natural motive forces include, but are not limited to wind, wave, ocean and river current, solar and geothermal. Artificial motive forces or those which are man-made or deriving from man-made technology include, but are not limited to heat engines and electrical motors.

The compressed fluid may be expanded immediately for the generation of power or other useful products, or may be stored for later expansion.

When used as an expander the invention may derive motive power or force from compressed and/or heated fluids, translating such force of pressure into mechanical or electrical power. The invention may also expand such compressed fluids directly into useful products such as isolated gases or liquefied air.

Wind

In one embodiment, the present invention is useful in wind-driven applications. As used herein, the term “wind-driven applications” include those applications or uses of the present invention as either a compressor or expander or both in a process, device or method which captures, harnesses or otherwise exploits wind, wind power or wind energy.

As a motive force, wind can be harnessed, in conjunction with the present invention in improvements in compression and storage of compressed gas, as well as in the compression of gasses or fluids for storage and electricity generation.

In one embodiment, the motive force of the wind may be exploited using the present invention in technologies involving mechanical vapor recompression (MVR).

In one embodiment, the present invention employing wind as a motive force may act as a compressor to produce liquid air or liquid air products, and compress carbon dioxide for sequestration.

Wave

As a motive force, waves can be harnessed, in conjunction with the present invention in improvements in compression and storage of compressed gas, as well as in the compression of gasses or fluids for storage and electricity generation. In one embodiment, the motive force of waves may be exploited using the present invention in technologies involving mechanical vapor recompression (MVR).

In one embodiment, the present invention may be used in offshore applications.

In one embodiment, the present invention employing wave as a motive force may act as a compressor to produce liquid air or liquid air products, and compress carbon dioxide for sequestration.

Ocean Current

Further, the present invention may be integrated into ocean or river current technology for electricity generation as well as for offshore maritime or marine applications for power or electricity generation.

Distributed CAES

Further, the present invention may also be harnessed or exploited in the use of distributed Compressed Air Energy Storage (CAES) systems. This application also finds uses in electricity generation and storage. In one embodiment, the generation and/or storage may be at the customer side or end of the meter.

Power Recovery

When used as an expander, the present invention may be powered by any number of heat sources, natural or artificial. For example, when a process or method employs the use of steam or vapor, the heat necessary to generate the steam or vapor may come from any number or sources. Heat sources include, but are not limited to solar, geothermal, radioactive (nuclear) and chemical. Also included are exhausts from other processes and the combustion of fuel, including waste heat and intentional heat.

In many processes of energy production, much energy is lost to the system and surroundings as heat. Waste heat recovery therefore represents an attractive avenue for improving and optimizing any heat-generating system. For example, engines represent a major class of prime movers in society. These prime movers generate a great deal of waste heat that, if captured and exploited, could reduce the overall cost of systems using them. Waste heat recovery may also be effected from incineration, anaerobic digestion, composting, radioactive, mechanical biological treatments, recycling plants and processes, sewerage, biogas recovery, landfill gas recovery, biomass gasification. Industrial processes which could benefit from incorporation of the machine of the present invention include, for example, aluminum smelting, metal casting, steel processing, glass making and chemical processing including manufacture or processing of fertilizers or in the production or refining of hydrocarbon fuels including gasoline.

To this end, the present invention may be used to capture waste heat from engines in many processes.

Applications of the present invention include, bottoming cycle expanders for power recovery from waste heat of diesel/gas powered engines including microturbines, backpressure steam expanders for power recovery from district heating/distributed steam pressure reduction), boiler cogeneration expanders and micro cogeneration expanders for recovery of power from waste heat, and as chiller expanders for the recovery of power from expansion of refrigerant. In all these cases the recovered mechanical power may be used directly or to drive a generator to produce electricity.

As used herein a “GenSet” is any distributed generator system or electrical generator such as a diesel, natural gas, or gasoline powered generator located in proximity to the end-user rather than in a central location such as those utilized by commercial power providers. A genset can be utilized as an augmentation to an existing electrical grid system or as an “off-grid” power source depending upon the needs of the user. Gensets are often used by hospitals and other industries which rely upon a steady source of power, as well as in rural areas where there is no access to commercially generated (‘grid’) electricity.

The present invention may also be used in conjunction with gas pipelines for electricity generation (e.g., power recovery from reduction of transmission to distribution pressure) and in microturbine combined cycles (e.g., power recovery from waste heat of microturbine fuel combustion).

Process Applications

The present invention also finds utility in several processes including, but not limited to process compression and process expansion of working fluids.

In one embodiment the present invention may be used in air compression applications such as in pneumatics for tools or machinery. In some embodiments the compressor may be coolant injected or water injected.

In one embodiment the present invention may be used in natural gas compression, gas field/wellhead compression into collection system or compression to transmission pipeline pressure.

As an expander the present invention may be employed in natural gas regasification and for removal of contaminants from natural gas.

Process Compression

Within the field of process compression the present invention may be exploited in chemical processes such as separation processes including air and constituent gas separation. These processes may include the separation of hydrocarbon gases and related gas separations as well as petrochemical refining. In these processes a compressed gas is cooled causing constituents such as long chain hydrocarbons (greater than 3 carbons) to drop out of the mixture. It is also possible to recover power from this expansion process.

In one embodiment steam or vapor upgrade or evaporation enhancement can be accomplished using the compressor of the present invention. For example, a compression cycle may be used to create steam or vapor at a higher pressure from steam at a lower pressure instead of making the higher pressure steam from ambient working fluids.

In one embodiment, the present invention can be used in the food processing industry.

Refrigeration/HV AC/Air Cycles

The present invention may be employed in any number of compression or expansion processes within devices involving air cycles. In this manner, the present invention may be used for compressing refrigerants in heat pumps, chillers and in refrigeration cycles. It may also be used for compressing refrigerants that are condensing as well as gas cycle refrigerants. In addition to conventional refrigerants the compressor may employ as a working fluid natural refrigerants such as carbon dioxide (CO₂), air and ammonia.

Devices which may be configured or manufactured to utilize the present invention include, but are not limited to, air separation units (ASUs), air conditioning systems, packaged condensing units (e.g., air conditioning units located on the roofs of commercial buildings) and splits (e.g., medium sized air conditioners). In one embodiment the present invention may be used in integrated chillers/refrigeration units (window air conditioners) or in stand-alone air conditioners. The devices may be further intercooled. Technological application of cryogenics may also utilize the present invention.

Distillation/MVR (Mechanical Vapor Recompression)

In one embodiment, the present invention may be applied in the field of distillation or mechanical vapor recompression (including for distillation). Irrespective of motive force, the machine of the present invention may be used to facilitate these processes.

To this end, the present invention may be used in the process of petroleum processing, distillation of ethanol or other alcohols or alcohol-containing liquids, water purification and constituent or waste separation/concentration.

CO₂ Compression/Sequestration

The present invention may be used in the separation/sequestration of CO₂ as, for example, in the process of enhancing oil recovery. It may also be used in the compression of gases originating from flue gas separations or flue gas processes.

Automotive

The machine of the present invention may be used in many aspects of the automotive industry. As used herein “automotive” embraces on-road and off-road vehicles including military, construction, mining and farm vehicles. Also included are aircraft and marine vehicles and applications therein.

To this end, the present invention may be used as an automotive supercharger, or as the compressor or heat pump in an automotive air conditioning system, It may also be integrated into automotive exhaust systems (potentially replacing conventional blowers) or used for air braking. It may also be for bottoming cycle power (waste heat) recovery as an alternative to turbo-compounding. Further, the present invention may be used in hybrid air accumulation (supercharger) such as those in hybrid vehicles.

Other Applications

In addition, the present invention may be used in fuel cells, vacuum pumps, liquid pumps, heat pumps and for any application requiring a compressor or expander in solar heat power generation.

The dimensions and ranges herein are set forth solely for the purpose of illustrating typical device dimensions. The actual dimensions of a device constructed according to the principles of the present invention may obviously vary outside of the listed ranges with departing from those basic principles. Further, it should be apparent to those skilled in the art that various changes in form and details of the invention as shown and described may be made. It is intended that such changes be included within the spirit and scope of the claims appended hereto.

What is claimed is:

1. A toroidal intersecting vane machine characterized by a primary and secondary vane each having an inner radius, an outer radius and an intermeshing surface wherein, at every phase during an intermeshing phase, an overlap region exists between the primary and secondary vanes containing a connected area extending continuously from the inner radius to the outer radius of the overlap characterized by a maximal gap distance of less than about 0.25 inches.

2. The machine of claim 1 wherein the maximal gap distance is less than about 0.1 inches.

3. The machine of claim 1 wherein the maximal gap distance is less than less than about 0.001 inches.

4. A toroidal intersecting vane machine characterized by a primary and secondary vane each having an inner radius, an outer radius and an intermeshing surface wherein, at every phase during an intermeshing phase, an overlap region exists between the primary and secondary vanes containing a connected area extending continuously from the inner radius to the outer radius of the overlap characterized by a maximal gap distance of less than about 10% of the radial height of the primary vane.

5. The machine of claim 4 wherein the maximal gap distance is less than about 1%.

6. The machine of claim 4 wherein the maximal gap distance is less than about 0.01%.

7. The machine of claim 1 wherein the admissible portion of the overlap region at phase s, when the overlap region has area greater than 0, is at least about 1% of the total surface area of the overlap region between the intermeshing surfaces.

8. The machine of claim 7 wherein the admissible portion of the overlap region, when the overlap region has area greater than 0, is at least about 20% of the total surface area of the overlap region between the intermeshing surfaces.

9. The machine of claim 1 wherein the intermeshing surfaces are ruled surfaces.

10. The machine of claim 1 wherein the intermeshing surfaces are the same.

11. A toroidal intersecting vane machine characterized by a primary and secondary vane each having an intermeshing surface approximated by the following equations:
$$\begin{matrix}{Surf}_{x} ( t , r ) = - \frac{( MajRad {ω}_{1}^{2} + r ( {ω}_{2}^{2} + {ω}_{1}^{2} ) ) {t}^{2}}{2} + MajRad + r & ( 0.49 ) \\ {Surf}_{y} ( t , r ) = {ω}_{2} \frac{{c}_{y 2} ( MajRad {ω}_{1}^{2} + r ( {ω}_{2}^{2} + {ω}_{1}^{2} ) ) {t}^{3}}{6} - r {ω}_{2} t & ( 0.50 ) \\ {Surf}_{z} ( t , r ) = {ω}_{1} \frac{( MajRad {ω}_{1}^{2} + r ( {ω}_{2}^{2} + {ω}_{1}^{2} ) ) {t}^{3}}{6} - ( MajRad + r ) {ω}_{1} t . & ( 0.51 )\end{matrix}$$

12. A toroidal intersecting vane machine characterized by a primary and secondary vane each having an intermeshing surface defined by the following equations:
$$\begin{matrix}{Surf}_{x} ( t , r ) = - \frac{( MajRad {ω}_{1}^{2} + r ( {ω}_{2}^{2} + {ω}_{1}^{2} ) ) {t}^{2}}{2} + MajRad + r & ( 0.49 ) \\ {Surf}_{y} ( t , r ) = {ω}_{2} \frac{{c}_{y 2} ( MajRad {ω}_{1}^{2} + r ( {ω}_{2}^{2} + {ω}_{1}^{2} ) ) {t}^{3}}{6} - r {ω}_{2} t & ( 0.50 ) \\ {Surf}_{z} ( t , r ) = {ω}_{1} \frac{( MajRad {ω}_{1}^{2} + r ( {ω}_{2}^{2} + {ω}_{1}^{2} ) ) {t}^{3}}{6} - ( MajRad + r ) {ω}_{1} t . & ( 0.51 )\end{matrix}$$

13. A vane characterized by an intermeshing surface approximated by the following equations:
$$\begin{matrix}{Surf}_{x} ( t , r ) = - \frac{( MajRad {ω}_{1}^{2} + r ( {ω}_{2}^{2} + {ω}_{1}^{2} ) ) {t}^{2}}{2} + MajRad + r & ( 0.49 ) \\ {Surf}_{y} ( t , r ) = {ω}_{2} \frac{{c}_{y 2} ( MajRad {ω}_{1}^{2} + r ( {ω}_{2}^{2} + {ω}_{1}^{2} ) ) {t}^{3}}{6} - r {ω}_{2} t & ( 0.50 ) \\ {Surf}_{z} ( t , r ) = {ω}_{1} \frac{( MajRad {ω}_{1}^{2} + r ( {ω}_{2}^{2} + {ω}_{1}^{2} ) ) {t}^{3}}{6} - ( MajRad + r ) {ω}_{1} t . & ( 0.51 )\end{matrix}$$

14. A vane characterized by an intermeshing surface defined by the following equations:
$$\begin{matrix}{Surf}_{x} ( t , r ) = - \frac{( MajRad {ω}_{1}^{2} + r ( {ω}_{2}^{2} + {ω}_{1}^{2} ) ) {t}^{2}}{2} + MajRad + r & ( 0.49 ) \\ {Surf}_{y} ( t , r ) = {ω}_{2} \frac{{c}_{y 2} ( MajRad {ω}_{1}^{2} + r ( {ω}_{2}^{2} + {ω}_{1}^{2} ) ) {t}^{3}}{6} - r {ω}_{2} t & ( 0.50 ) \\ {Surf}_{z} ( t , r ) = {ω}_{1} \frac{( MajRad {ω}_{1}^{2} + r ( {ω}_{2}^{2} + {ω}_{1}^{2} ) ) {t}^{3}}{6} - ( MajRad + r ) {ω}_{1} t . & ( 0.51 )\end{matrix}$$

15. A vane characterized by two intermeshing surfaces defined by the following equations:
$$\begin{matrix}{Surf}_{x} ( t , r ) = - \frac{( MajRad {ω}_{1}^{2} + r ( {ω}_{2}^{2} + {ω}_{1}^{2} ) ) {t}^{2}}{2} + MajRad + r & ( 0.49 ) \\ {Surf}_{y} ( t , r ) = {ω}_{2} \frac{{c}_{y 2} ( MajRad {ω}_{1}^{2} + r ( {ω}_{2}^{2} + {ω}_{1}^{2} ) ) {t}^{3}}{6} - r {ω}_{2} t & ( 0.50 ) \\ {Surf}_{z} ( t , r ) = {ω}_{1} \frac{( MajRad {ω}_{1}^{2} + r ( {ω}_{2}^{2} + {ω}_{1}^{2} ) ) {t}^{3}}{6} - ( MajRad + r ) {ω}_{1} t . & ( 0.51 )\end{matrix}$$

16. A toroidal intersecting vane machine characterized by a primary and secondary vane each having an intermeshing surface defined by the following equations:
Surfₓ(t,r)=cos(tω₁)(((MajRad+r)cos(tω₁)−MajRad)cos(tω₂)+MajRad) (0.52)
Surf_{y}(t,r)=−((MajRad+r)cos(tω₁)−MajRad)sin(tω₂) (0.53)
Surf_{z}(t,r)=sin(tω₁)(((MajRad+r)cos(tω₁)−MajRad)cos(tω₂)+MajRad). (0.54)

17. A vane characterized by two intermeshing surfaces defined by the following equations:
Surfₓ(t,r)=cos(tω₁)(((MajRad+r)cos(tω₁)−MajRad)cos(tω₂)+MajRad) (0.52)
Surf_{y}(t,r)=−((MajRad+r)cos(tω₁)−MajRad)sin(tω₂) (0.53)
Surf_{z}(t,r)=sin(tω₁)(((MajRad+r)cos(tω₁)−MajRad)cos(tω₂)+MajRad). (0.54)
